(19) United States
(12) Patent Application Publication
(10) Pub. No.: US 2025/0021762 A1
(43) Pub. Date: Jan. 16, 2025

(54) LANGUAGE PROCESSING APPARATUS, IMAGE PROCESSING METHOD, AND PROGRAM

(71) Applicant: NIPPON TELEGRAPH AND TELEPHONE CORPORATION, Tokyo (JP)

(72) Inventors: Yasuhito OSUGI, Tokyo (JP); Itsumi SAITO, Tokyo (JP); Kyosuke NISHIDA, Tokyo (JP); Sen YOSHIDA, Tokyo (JP)

(21) Appl. No.: 18/714,677

(22) PCT Filed: Dec. 1, 2021
(86) PCT No.: PCT/JP2021/044112

§ 371 Date: May 30, 2024

(51) Int. Cl. G06F 40/284; G06F 40/268; G06F 40/40; G06N 3/0895

(52) U.S. Cl. CPC G06F 40/284; G06F 40/268; G06F 40/40; G06N 3/0895

(57) ABSTRACT

A language processing device includes circuitry configured to generate an error sentence corresponding to an original sentence based on pronunciation corresponding to text data indicating the original sentence; use a language model based on a neural network model to generate a prediction sentence from the error sentence based on a language model parameter of the language model; and update the language model parameter based on a difference between the original sentence and the prediction sentence.

### TECHNICAL FIELD

The present disclosure relates to a language processing device, a language processing method, and a program.

### BACKGROUND ART

In recent years, research on language models such as Bidirectional Encoder Representations from Transformers (BERT) has progressed (refer to Non Patent Literature 1). A language model here is one of neural network models for obtaining a distributed representation of a token indicating one unit of a word included in a text sentence. In this case, instead of inputting a single token, all the text in which the token is used is input, so that a distributed representation (a technique of expressing a word with a high-dimensional real number vector, in which a word having a close meaning corresponds to a close vector) reflecting a semantic relation with other tokens in the text can be obtained. A step of learning the distributed representation will be referred to as pre-learning (pre-training). Various tasks such as a text classification task and a response-to-question task can be solved by using a pre-learned distributed representation, and this step will be referred to as fine-tuning.

In the model in Non Patent Literature 1, a highly accurate distributed representation of each token is learned through pre-training using a large number of language resources, so that high performance is exhibited even in each task in fine-tuning.

However, in order to exhibit high performance in fine-tuning, it is necessary to perform sufficient pre-training. Therefore, in the pre-training, two tasks such as a word filling task and a next sentence prediction task are used. The word filling task is a task of predicting a correct token by performing any operation of randomly sampling a token from an error token string c, replacing the token with a mask token, replacing the token with a random token, and holding the token without replacement.

For example, in the related art, when there is an original sentence “Kyou-wa-yoi-tenki-desu. [Weather is fine today.]” as illustrated in FIG. 12, a token string of an error sentence newly indicating “Kyou [today]/[MASK]/yo [good]/i/shoubousha [fire engine]/desu [is].” is obtained from a correct token string obtained by tokenizing the original sentence. (Here, “/” represents a break of the token) The token string is input to a language model, and the language model is trained such that the correct token string “Kyou [today]/wa/yo [good]/i/tenki [weather]/desu [is].” can be predicted. Note that since the language model of the related art is implemented by a neural network, a general supervised neural network learning method using a correct token string as a training label may be applied.

### CITATION LIST

### Non Patent Literature

Non Patent Literature 1: BERT <(https://arxiv.org/abs/1810.04805>

### SUMMARY OF INVENTION

### Technical Problem

However, in a case where the neural network model of the related art is applied to a task such as summarization of conversations by inputting a speech utterance in a call center, since the input is text data, it is necessary to convert the speech utterance into text through speech recognition, and an error in the speech recognition may occur in the conversion. Therefore, in order to accurately solve a task such as summarizing a conversation, it is necessary to accurately understand the content and intention of a sentence (error sentence) including an error in speech recognition.

In the related art, although the input of the word filling task can be said to be an artificially made error sentence as described above, since the phonological connection of the error token string c is not considered at all, it is not possible to cope with an error which is one of tendencies of speech recognition errors and which is phonologically close but has a different meaning, and as a result, it is not possible to accurately solve the conversation summarization using the speech recognition result. For example, in FIG. 12, an error sentence is created by replacing the “tenki [weather]” token with the “shoubousha [fire engine]” token. However, in actual speech recognition, it is considered that a “tenki [turning point]” token close in phonological terms has a higher probability of appearing as a mistake.

The present invention has been made in view of the above circumstances, and an object of the present invention is to perform processing of a training phase such that language processing can be performed as accurately as possible even in a case where an error that is phonologically close but has a different meaning is included in input data in an inference phase.

### Solution to Problem

In order to solve the above problem, an invention according to claim 1 is a language processing device that performs language processing, the language processing device including: an error generation unit that generates an error sentence corresponding to an original sentence on the basis of pronunciation corresponding to text data indicating the original sentence; a language model unit that is a language model based on a neural network model and generates a prediction sentence from the error sentence on the basis of a language model parameter of the language model; and an update unit that updates the language model parameter on the basis of a difference between the original sentence and the prediction sentence.

### Advantageous Effects of Invention

As described above, according to the present invention, there is an effect of performing processing in a training phase such that language processing can be performed as accurately as possible even in a case where an error that is phonologically close but has a different meaning is included in input data in an inference phase.

### BRIEF DESCRIPTION OF DRAWINGS

FIG. 1 is a schematic diagram of a communication system of the present embodiment.

FIG. 2 is a hardware configuration diagram of a language processing device and a communication terminal.

FIG. 3 is a functional configuration diagram of the language processing device according to the embodiment of the present invention.

FIG. 4 is a flowchart illustrating processing executed by the language processing device in a training (learning) phase.

FIG. 5 is a flowchart illustrating a process in which an error generation unit generates an error sentence.

FIG. 6 is a conceptual diagram of a process in which the error generation unit generates an error sentence.

FIG. 7 is a flowchart illustrating a process in which a label creation unit creates a token string of an error sentence and a correct token string.

FIG. 8 is a conceptual diagram of a process in which the label creation unit creates a token string of an error sentence and a correct token string.

FIG. 9 is a flowchart illustrating experimental processing for effect verification.

FIG. 10 is a table illustrating other experimental conditions.

FIG. 11 is a table illustrating experimental results.

FIG. 12 is a conceptual diagram illustrating conventional language processing.

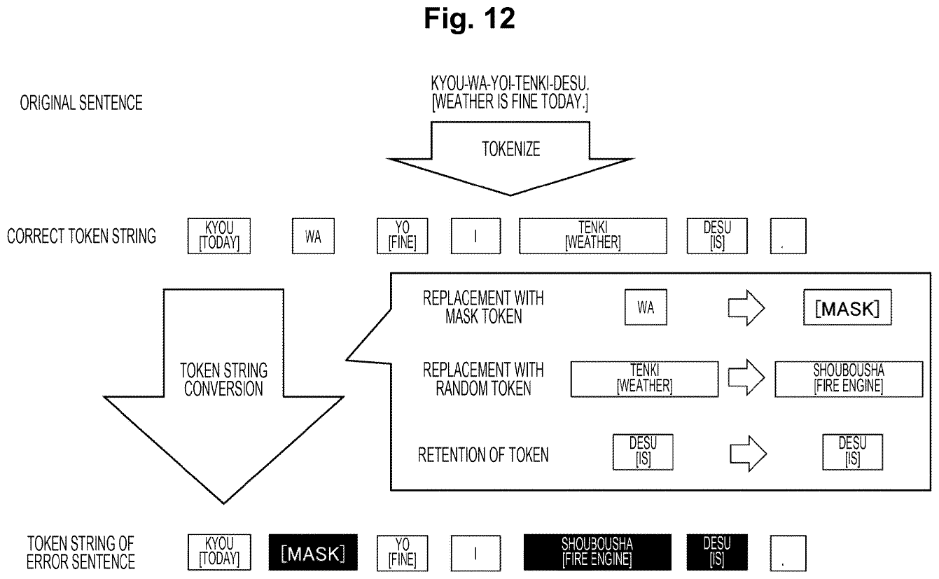

### DESCRIPTION OF EMBODIMENTS

Hereinafter, an embodiment of the present invention will be described with reference to the drawings.

### System Configuration of Embodiment

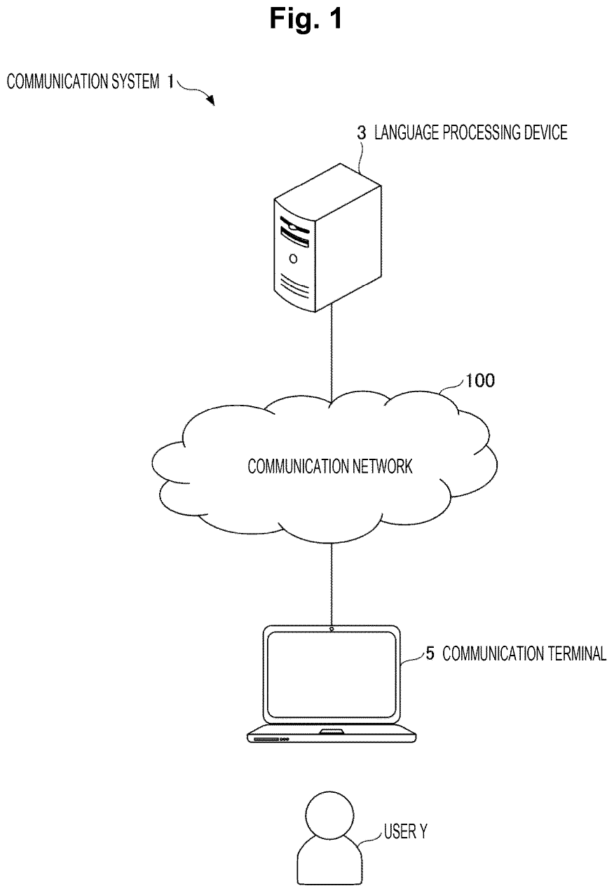

First, an outline of a configuration of a communication system 1 of the present embodiment will be described with reference to FIG. 1. FIG. 1 is a schematic diagram of the communication system according to the embodiment of the present invention.

As illustrated in FIG. 1, the communication system 1 of the present embodiment is constructed by a language processing device 3 and a communication terminal 5. The communication terminal 5 is managed and used by a user Y.

The language processing device 3 and the communication terminal 5 can communicate with each other via a communication network 100 such as the Internet. A connection form of the communication network 100 may be either a wireless or wired form.

The language processing device 3 includes one or a plurality of computers. In a case where the language processing device 3 includes a plurality of computers, it may be referred to as a “language processing device” or a “language processing system”.

The language processing device 3 updates language model parameters of a neural network model for extracting a feature amount from text data indicating an original sentence on the basis of the original sentence and an error sentence corresponding to the original sentence. For example, Bidirectional Encoder Representations from Transformers (BERT) is used as the neural network model. The language processing of the present embodiment is to execute an error sentence generation method using pronunciation of a word of a sentence and a pre-training method of a language model robust to a speech recognition error using this method. The language processing device 3 outputs data indicating the feature amount extracted from the text data of the original sentence as result data. As an output method, by transmitting result data to the communication terminal 5, a table or the like related to the result data is displayed or printed on the communication terminal 5 side, a table or the like is displayed on a display connected to the language processing device 3, or a table or the like is printed by a printer or the like connected to the language processing device 3.

The communication terminal 5 is a computer, and FIG. 1 illustrates a laptop personal computer as an example. However, the communication terminal 5 is not limited to a laptop PC, and may be a desktop personal computer. The communication terminal may be a smartphone or a tablet terminal. In FIG. 1, the user Y is operating the communication terminal 5.

### [Hardware Configurations of Language Processing Device and Communication Terminal]

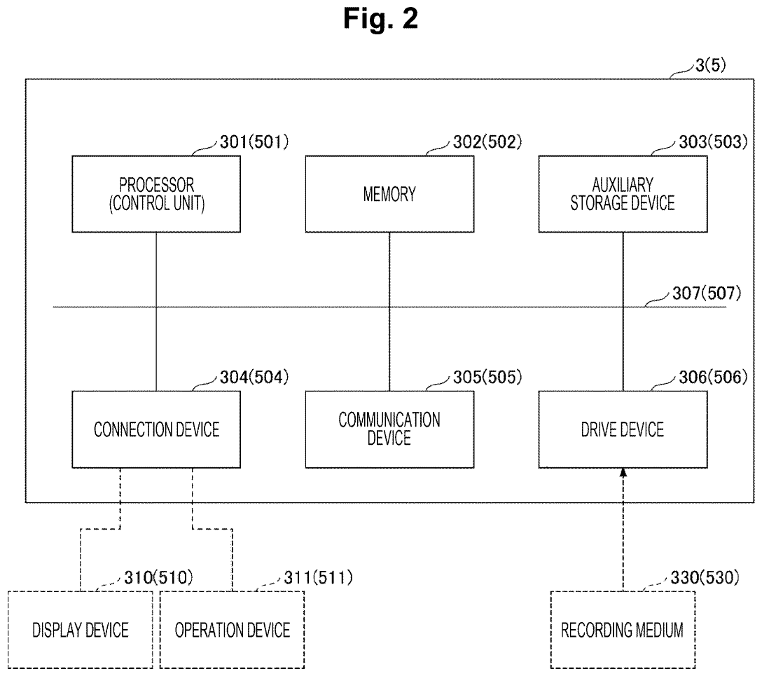

Next, hardware configurations of the language processing device 3 and the communication terminal 5 will be described with reference to FIG. 2. FIG. 2 is a hardware configuration diagram of the language processing device and the communication terminal.

As illustrated in FIG. 2, the language processing device 3 includes a processor 301, a memory 302, an auxiliary storage device 303, a connection device 304, a communication device 305, and a drive device 306. Note that the respective hardware constituents configuring the language processing device 3 are connected to each other via a bus 307.

The processor 301 serves as a control unit that controls the entire language processing device 3, and includes various arithmetic devices such as a central processing unit (CPU). The processor 301 reads and executes various programs on the memory 302. Note that the processor 301 may include a general-purpose computing on graphics processing units (GPGPU).

The memory 302 includes a main storage device such as a read only memory (ROM) and a random access memory (RAM). The processor 301 and the memory 302 form a so-called computer, and the processor 301 executes various programs read on the memory 302, so that the computer realizes various functions.

The auxiliary storage device 303 stores various programs and various types of information used when the various programs are executed by the processor 301.

The connection device 304 is a connection device that connects an external device (for example, a display device 310 and an operation device 311) to the language processing device 3.

The communication device 305 is a communication device for transmitting and receiving various types of information to and from other devices.

The drive device 306 is a device for setting a recording medium 330 therein. The recording medium 330 here includes a medium that optically, electrically, or magnetically records information, such as a compact disc read-only memory (CD-ROM), a flexible disk, or a magneto-optical disk. The recording medium 330 may include a semiconductor memory or the like that electrically records information, such as a read only memory (ROM) or a flash memory.

Note that the various programs installed in the auxiliary storage device 303 are installed, for example, by setting the distributed recording medium 330 in the drive device 306 and by the drive device 306 reading the various programs recorded on the recording medium 330. Alternatively, various programs installed in the auxiliary storage device 303 may be installed by being downloaded from a network via the communication device 305.

FIG. 2 illustrates a hardware configuration of the communication terminal 5, but since the respective constituents are the same only by changing the reference numerals from the 300 series to the 500 series, the description thereof will be omitted.

### [Functional Configuration of Language Processing Device]

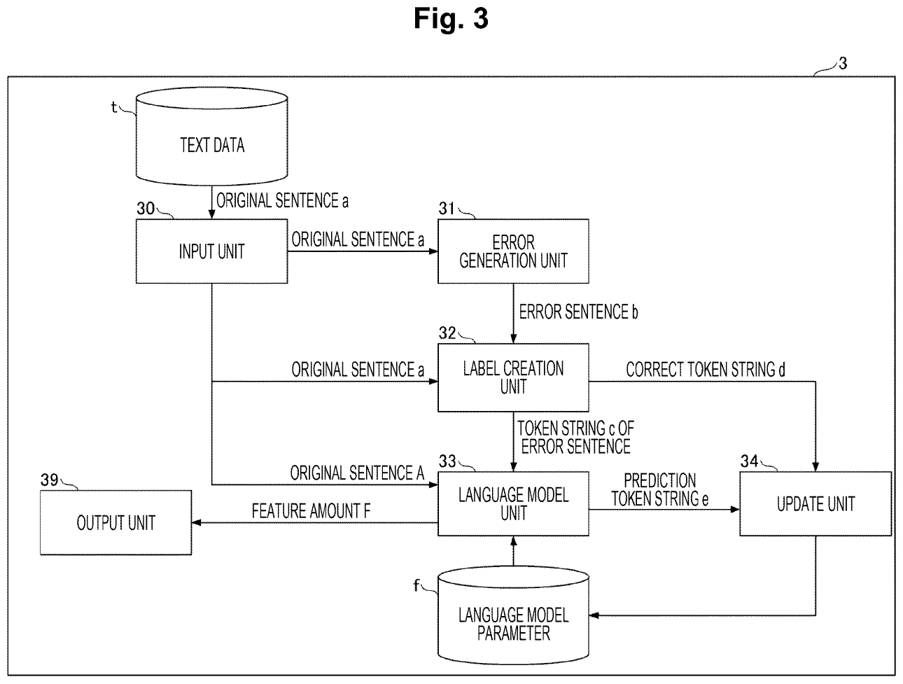

Next, a functional configuration of the language processing device will be described with reference to FIG. 3. FIG. 3 is a functional configuration diagram of the language processing device according to the embodiment of the present invention.

In FIG. 3, the language processing device 3 includes an input unit 30, an error generation unit 31, a label creation unit 32, a language model unit 33, an update unit 34, and an output unit 39. Each of these units is a function realized according to instructions by the processor 301 in FIG. 2 on the basis of a program.

The memory 302 or the auxiliary storage device 303 in FIG. 2 stores text data t and a language model parameter f. The text data t is, for example, text data acquired from a Web page, and is used in the training phase. The language model parameter f is a model parameter of machine learning performed by BERT or the like.

The input unit 30 receives the text data t from a Web page or the like.

The error generation unit 31 performs processing such as generating an error sentence by converting a predetermined morpheme (first morpheme) forming text data indicating an original sentence into “pronunciation” and converting a second morpheme based on the first morpheme after the conversion into “pronunciation” into a predetermined standard notation. Detailed processing of the error generation unit 31 will be described later.

The label creation unit 32 creates a correct token string by using a comparison label used for correction from the token string of the error sentence to the token string of the original sentence. Detailed processing of the label creation unit 32 will be described later.

The language model unit 33 is a neural network model that obtains a distributed representation of a token, and for example, a model using BERT or the like disclosed in Non Patent Literature 1 may be used. In the case of the training (learning) phase, the language model unit 33 acquires the token string c of the error sentence from the label creation unit 32, and creates and outputs a prediction token string e by using the language model parameter f. In the case of the inference phase, the language model unit 33 receives an original sentence A, vectorizes a text pattern of text data of the original sentence A, and extracts a text feature amount F.

The update unit 34 updates the language model parameter f on the basis of the correct token string d acquired from the label creation unit 32 and the prediction token string e acquired from the language model unit 33. This update may be performed similarly to that in the supervised learning of the normal neural network.

The output unit 39 acquires the feature amount F from the language model unit 33 and outputs the feature amount F to the outside as result data.

Note that the error generation unit 31 handles morphemes without handling tokens of text data, whereas the label creation unit 32, the language model unit 33, and the update unit 34 are different in handling tokens (morphemes in some cases). The morpheme referred to herein may be any unit as long as it is a unit suitable for giving a pronunciation. For example, in the case of English, the word unit is used. On the other hand, the token may be any unit as long as it is accepted by the neural network or may be a morpheme. In general, a subword is often used.

The reason why the error generation unit 31 does not handle a token as described above is that, in the case of the token, for example, words having one meaning of “daihyou [leader]” may be divided into “dai” and “hyou”, which are inappropriate for processing in consideration of “pronunciation” as in the present embodiment. On the other hand, since a morpheme is a word meaning “daihyou [leader]”, morphological analysis is performed to generate “pronunciation”.

### Process or Operation of Embodiment

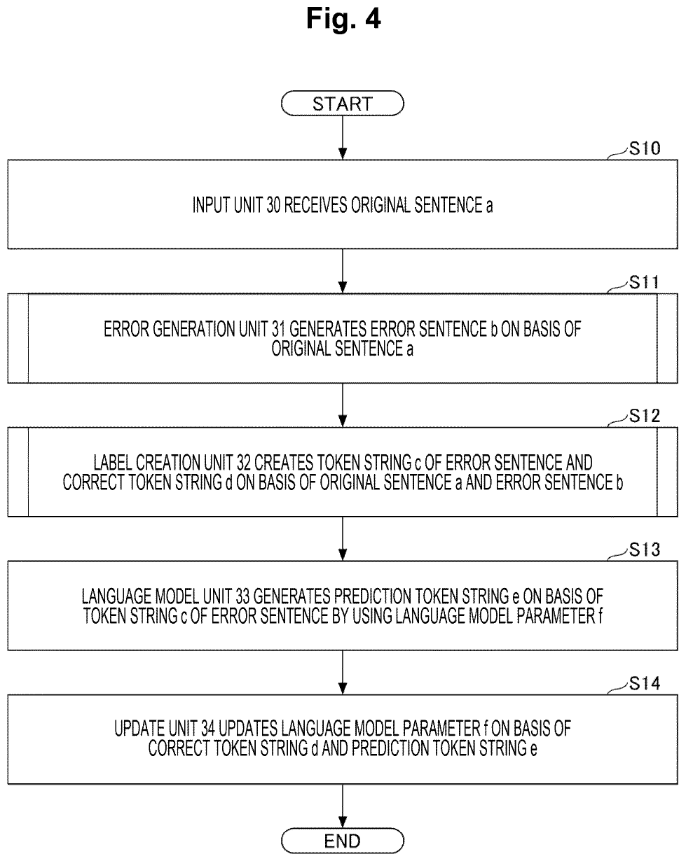

Next, a process or an operation of the present embodiment will be described in detail with reference to FIGS. 4 to 8.

### <Training (Learning) Phase>

First, a process in the training (learning) phase will be described with reference to FIG. 4. FIG. 4 is a flowchart illustrating a process executed by the language processing device in the training (learning) phase.

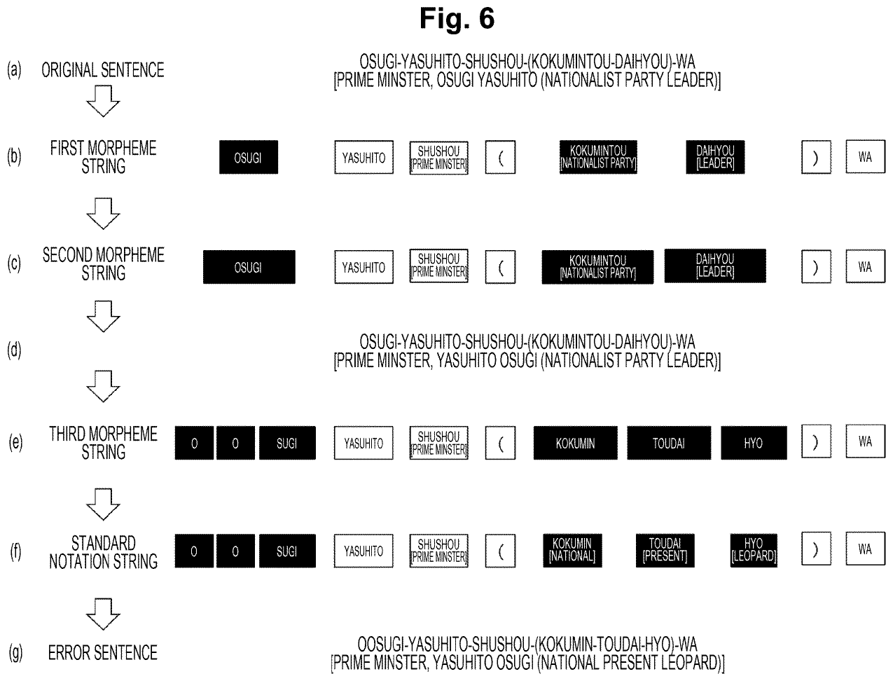

First, the input unit 30 samples and receives the original sentence a from the text data t (S10). The original sentence a may not necessarily be completed as a complete sentence. For example, as illustrated in FIG. 6(a), the original sentence an also includes an incomplete character string such as “Osugi-Yasuhito-shushou-(kokumintou-daihyou)-wa [Prime minster, Osuai Yasuhito (nationalist party leader)]”.

Next, the error generation unit 31 generates an error sentence b on the basis of the original sentence a of the text data t (S11).

### (Generation of Error Sentence)

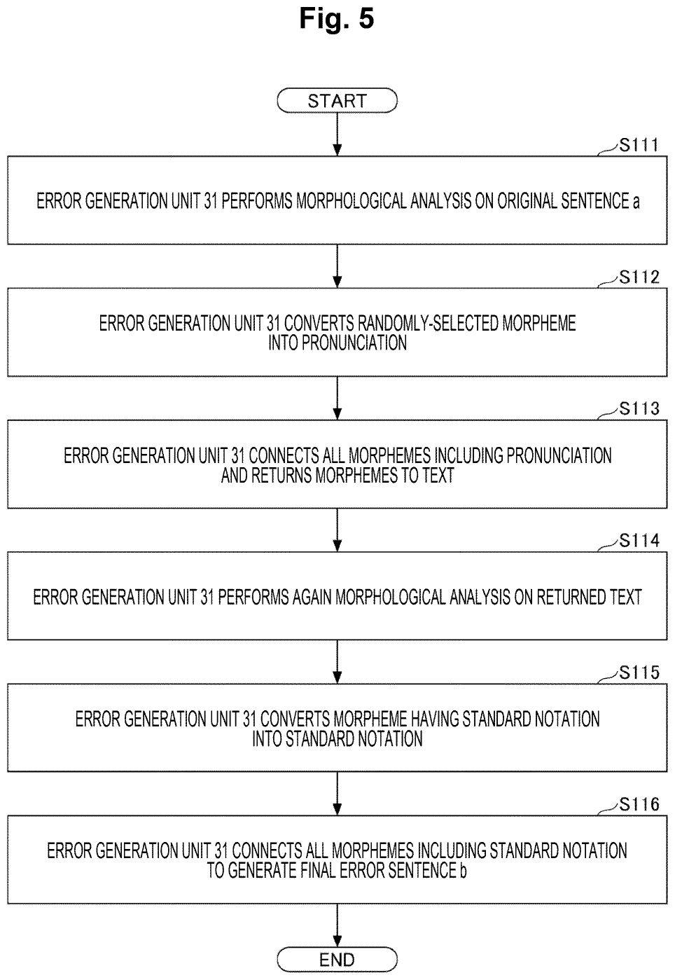

Here, detailed processing of the error generation unit 31 will be described with reference to FIGS. 5 and 6. FIG. 5 is a flowchart illustrating a process in which the error generation unit generates an error sentence. FIG. 6 is a conceptual diagram of a process in which the error generation unit generates an error sentence. Note that the error sentence obtained through a series of operations (processes) illustrated in FIG. 5 has an error close to an error in speech recognition in consideration of how to read the sentence.

First, as illustrated in FIGS. 6(a) and 6(b), the error generation unit 31 performs morphological analysis on the text data indicating the original sentence a to generate a first morpheme string including a plurality of morphemes (S111).

Next, the error generation unit 31 converts a morpheme selected randomly from the first morpheme string (an example of a first morpheme) into a “pronunciation” (in the case of Japanese, “hiragana”) (S112). For example, the error generation unit 31 converts the morphemes (“oosugi”, “kokumintou [nationalist party]”, and “daihyou [leader]”) selected randomly as illustrated in FIG. 6(b) into “oosugi”, “kokumintou”, and “daihyou”, respectively, as illustrated in FIG. 6(c). The token string of the original sentence in this state is a second morpheme string.

Next, as illustrated in FIG. 6(d), the error generation unit 31 connects all of the plurality of morphemes including the morphemes of “pronunciation” and returns the morphemes to text data (S113).

Next, the error generation unit 31 again performs morphological analysis on the returned text data (S114). For example, as illustrated in FIG. 6(e), the error generation unit 31 performs the morphological analysis on the returned text data again to generate a third morpheme string.

Next, the error generation unit 31 converts the morpheme having the standard notation (an example of a second morpheme) into the standard notation (S115). For example, as illustrated in FIG. 6(f), the error generation unit 31 generates the standard notation column by converting “kokumin” into “kokumin [national]”, “toudai” into “toudai [present]”, and “hyou” into “hyou [leopard]”. Note that the standard notation is, for example, a Chinese character first described corresponding to a hiragana character when a Japanese dictionary is checked with the hiragana character.

Finally, as illustrated in FIG. 6(g), the error generation unit 31 generates a final error sentence (here, an error sentence b) by connecting all the morphemes including the standard notation (S116).

As described above, the error generation unit 31 artificially generates the error sentence on the basis of “pronunciation” (reading) of the text.

Next, referring back to FIG. 4, the label creation unit 32 creates the token string c of the error sentence and the correct token string d on the basis of the original sentence a and the error sentence b (S12).

### (Label Creation)

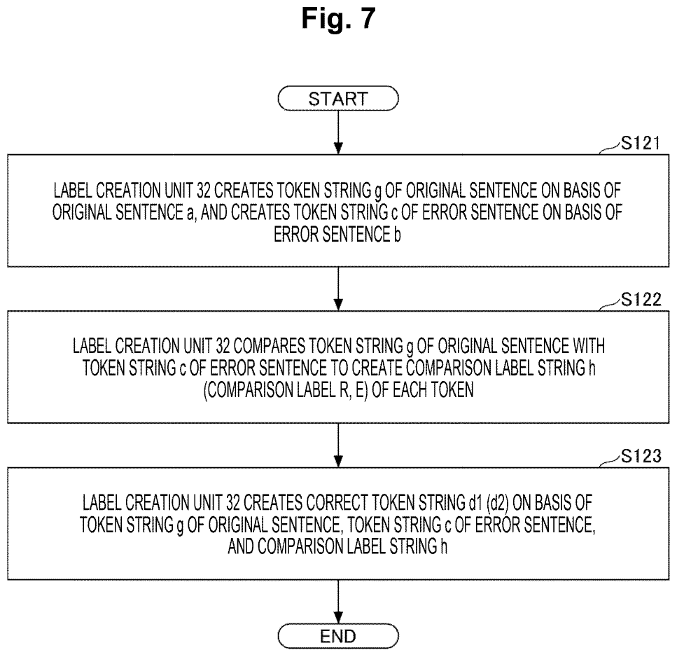

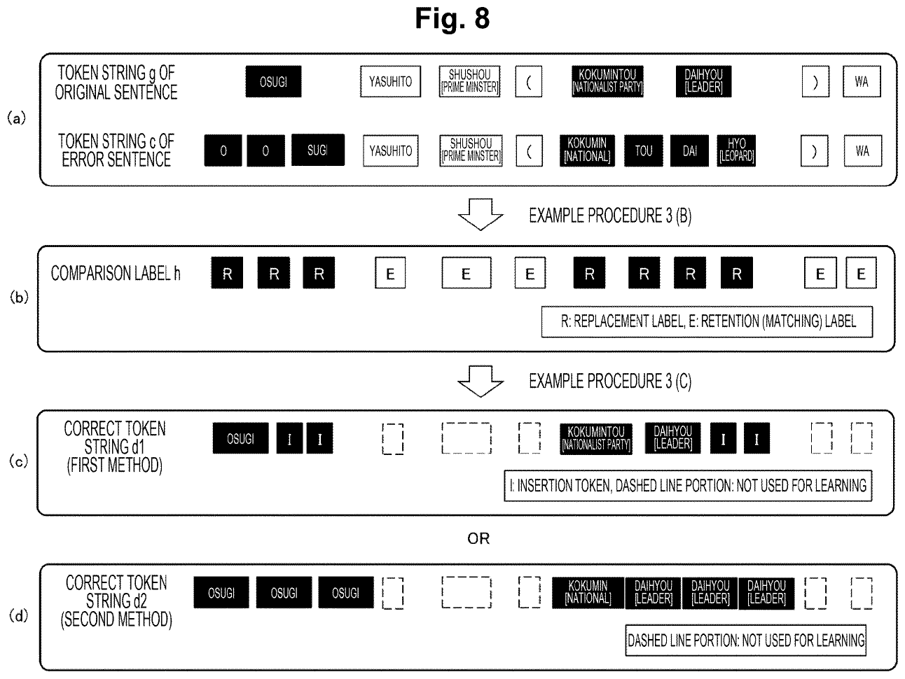

Here, detailed processing of the label creation unit 32 will be described with reference to FIGS. 7 and 8. FIG. 7 is a flowchart illustrating a process in which the label creation unit creates a token string of an error sentence and a correct token string. FIG. 8 is a conceptual diagram of a process in which the label creation unit creates a token string of an error sentence and a correct token string.

First, the label creation unit 32 creates a token string g of the original sentence on the basis of the original sentence a, and creates the token string c of the error sentence on the basis of the error sentence b (S121). For example, as illustrated in FIG. 8(a), the label creation unit 32 tokenizes the original sentence a into a token string g of the original sentence by using an appropriate tokenizer that decomposes the original sentence a into tokens. Similarly, the label creation unit 32 tokenizes the error sentence b into the token string c of the error sentence by using an appropriate tokenizer.

Next, the label creation unit 32 compares the token string g of the original sentence with the token string c of the error sentence, and creates a comparison label string h of each token (S122). For example, the label creation unit 32 creates a comparison label string h according to a method in Reference Literature 1 (Gestalt pattern matching <https://www.drdobbs.com/database/pattern-matching-the-gestalt-approach/184407970?pgno=5>) and assigns the comparison label string h to a predetermined token. This method is illustrated in FIG. 8(b).

As illustrated in FIG. 8(b), in order to compare the token string g of the original sentence with the token string c of the error sentence and correct the token string c of the error sentence to the token string g of the original sentence, the label creation unit 32 creates each comparison label indicating which token in the token string c of the error sentence is to be processed (deletion, replacement, insertion, or retention) and assigns the generated comparison label to the corresponding token.

Examples of the type of the comparison label forming the comparison label column h include a deletion label D indicating deletion (Delete), a replacement label R indicating replacement (Replacement), an insertion label I indicating insertion (Inset), and a retention label E indicating retention (Retention) (or matching). Note that, since insertion and deletion may be expressed as replacement with “blank”, only the replacement label R and the retention label E may be used. Since the replacement may be expressed by deletion and insertion, the replacement label R may not be used. The retention may be used in a case where no label is provided for the retention label E as meaning that a state is maintained.

In FIG. 8(b), a replacement label R is given to each token of “o”, “o”, “sugi”, “kokumin [national]”, “tou”, “dai”, and “hyou [leopard]”, and a retention label E is given to the other tokens. This means that the token string c of the error sentence can be corrected to the token string g of the original sentence by replacing the portions “o”, “o”, and “sugi” with “oosugi” and replacing the portions “kokumin [national]”, “tou”, “dai”, and “hyou [leopard]” with “kokumintou [nationalist party]” and “leader”.

Note that, in a case where a history of processing (which characters were converted into what hiragana and which kanji were returned) of the error generation unit 31 and the label creation unit 32 is retained, the label creation unit 32 may give a comparison label on the basis of the retained history information. In this case, it is not necessary to use the technique disclosed in Reference Literature 1.

Finally, the label creation unit 32 creates the correct token string d on the basis of the token string g of the original sentence, the token string c of the error sentence, and the comparison label string h (S123). A reguirement for this processing is to assign a correct token that can reproduce the same sentence as the token string g of the original sentence to an error (incorrect) token in the token string c of the error sentence with reference to the comparison label string h. Since the token to which the retention label E is given as the comparison label is considered as a “non-error token”, the label creation unit 32 does not use this error token for training (learning).

There are several possible methods for creating a correct token string, and two of them will be described below.

First, as a method of creating a correct token string d1 (first method), there is a method of assigning a label as disclosed in Reference Literature 2 (Section 3 of WLM <<https://arxiv.org/pdf/2011.01900.pdf> and FIG. 1) as illustrated in FIG. 8(c). This method (first method) is a method of assigning the insertion label I to an unnecessary token in the token string of the error sentence, and assigning the token to an insufficient portion in the input string as a label. In the example om FIG. 8(c), the label creation unit 32 assigns the “oosugi” token to the first “o” token, and assigns the insertion label I to each of the second “o” and “sugi” tokens.

As a method of creating a correct token string d2 (second method), as illustrated in FIG. 8(d), there is a method of assigning the “oosugi” token to each token of “No”, “o”, and “sugi”.

Next, referring back to FIG. 4, the language model unit 33 generates the prediction token string e according to a known method using BERT or the like on the basis of the token string c of the error sentence by using the language model parameter f (S13).

Next, the update unit 34 updates the language model parameter f according to a known method using BERT or the like on the basis of the correct token string d and the prediction token string e (S14).

As a result, the processing in the training (learning) phase ends.

### <Inference Phase>

In the inference phase, the input unit 30 receives text data (original sentence A) in which a speech utterance related to the speech data is converted into text through speech recognition, and as in the related art, the language model unit 33 generates the feature amount F by vectorizing the text data indicating the original sentence A by using the (learned) language model parameter f used for training. The output unit 39 outputs the feature amount as result data. The feature amount as the result data is then used for estimation of a conversation act or the like.

Note that audio data input by the input unit 30 is an example of input data. Another example of the input data is text data including characters that are phonologically close but have different meanings. Such text data is caused by, for example, erroneous conversion in keyboard input.

### Experimental Example

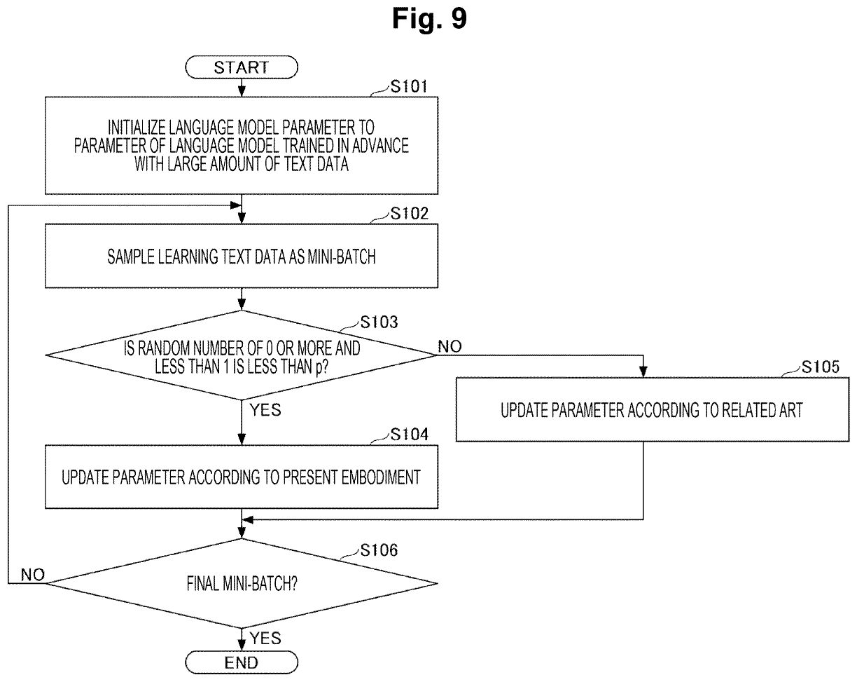

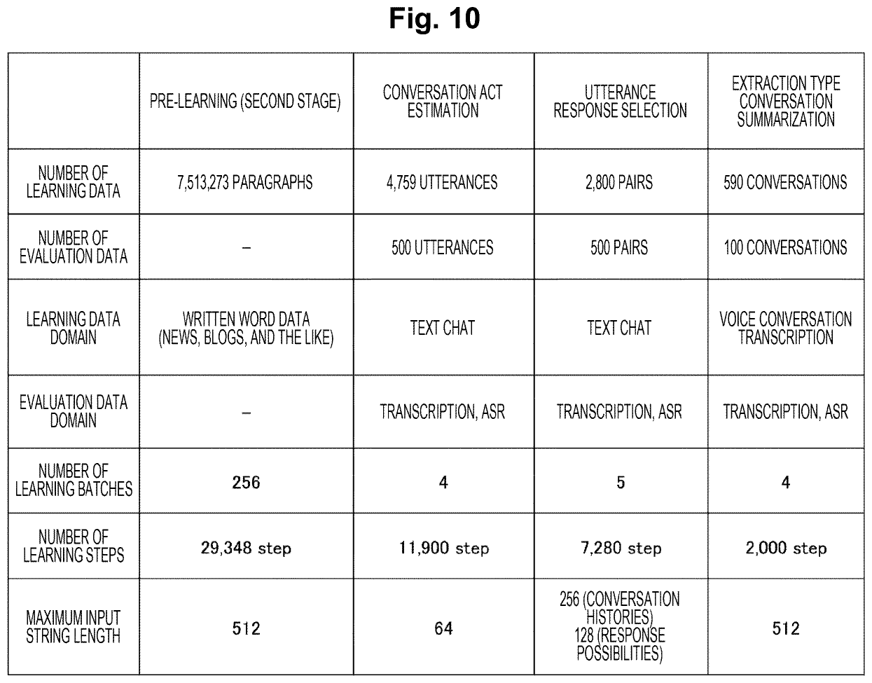

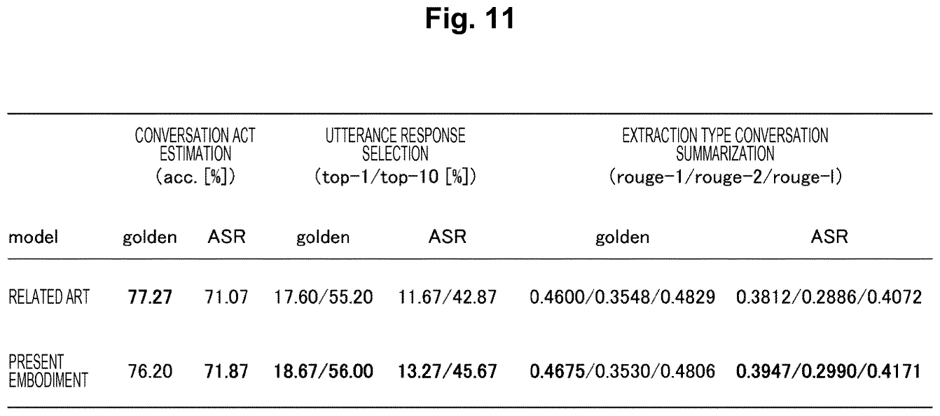

Next, an experimental example for verifying the effect of the present embodiment will be described with reference to FIGS. 9 to 11. FIG. 9 is a flowchart illustrating experimental processing for effect verification. FIG. 10 is a table illustrating other experimental conditions. FIG. 11 is a table illustrating experimental results.

In order to verify the effect of the present embodiment, we conducted an experiment of pre-training a model (BERT) disclosed in Non Patent Literature 1 (related art) by using the present embodiment, and fine-tuning into three types of tasks: a conversation action estimation task, an utterance response selection task, and an extraction type conversation summarization task related to voice conversation. However, the pre-training was performed, for example, BERT was trained in advance according to the method in Section 3.1 disclosed in Non Patent Literature 1 by using a large amount of text data, and additional learning was performed by using the method of the present embodiment. In the second stage, the tasks described in the present embodiment and Non Patent Literature 1 are switched for each sample such that a hyperparameter p is provided, the correction task of the present embodiment is performed with the probability p, and the Masked LM task in Section 3.1, Task #1 disclosed in Non Patent Literature 1 is performed with the probability 1-p (refer to FIG. 9). Other experimental conditions are illustrated in FIG. 10 and experimental results are illustrated in FIG. 11. As illustrated in FIG. 11, the accuracy is improved particularly in a case where the speech recognition result is input in the above-described three tasks, and the effect of the present embodiment is confirmed.

Here, specific experimental processing will be described with reference to FIG. 9.

First, the language model unit 33 initializes the language model parameter to a parameter of the language model trained in advance with a large amount of text data (101). Next, the input unit 30 samples the learning text data t as a mini-batch (S102). In a case where a random number of 0 or more and less than 1 is less than p (S103; YES), the language model unit 33 updates the language model parameter f according to the above-described embodiment (S104). On the other hand, in a case where the random number of 0 or more and less than 1 is equal to or more than p (S103; NO), the language model unit 33 updates the language model parameter f according to the above-described related art (S105). After the processes in steps S104 and S105, in a case where the mini-batch is not the last mini-batch (S106; NO), the flow returns to the process in step 102, and new sampling is performed. On the other hand, in the case of the last mini-batch (S106; YES), the experiment ends.

### Main Effects of Embodiment

As described above, according to the present embodiment, the language processing device 3 can create the language model reflecting the phonological connection by artificially creating the error sentence on the basis of “pronunciation” of text through the morphological analysis and performing pre-training to correct the error sentence and restore the original sentence. As described above, the language processing device 3 can create an error sentence close to an error in speech recognition in consideration of the “pronunciation” of the text. Therefore, even in a case where the input data is voice data in the inference phase, the language processing device 3 can perform the processing in the training phase so that the language processing can be performed as accurately as possible. The language processing device 3 compares the error sentence with the correct original sentence, and corrects the error sentence, so that it is possible to identify a portion that is close in terms of speech but is incorrect as a word or a token, and learn a tendency of an error. Therefore, it is also possible to accurately solve (execute) a task such as conversation summarization using an actual speech recognition result as an input.

### [Supplement]

The present invention is not limited to the above-described embodiment, and may be configured or processed (operated) as described below.

The language processing device 3 can be implemented by a computer and a program, but the program may be recorded on a (non-transitory) recording medium or provided via the communication network 100.

### (Supplementary Notes)

The above-described embodiments can also be expressed as the following inventions.

### [Supplementary Note 1]

A language processing device including a language model based on a neural network model and a processor that performs language processing, in which
the processor is configured to:
generate an error sentence corresponding to an original sentence on the basis of pronunciation corresponding to text data indicating the original sentence;
generate a prediction sentence from the error sentence on the basis of a language model parameter of the language model; and
update the language model parameter on the basis of a difference between the original sentence and the prediction sentence.

### [Supplementary Note 2]

The language processing device according to Supplementary Note 1, in which the processor generates the error sentence by converting a first morpheme, which serves as a predetermined morpheme forming the text data indicating the original sentence, on the basis of pronunciation into a second morpheme and converting the second morpheme into a predetermined standard notation.

### [Supplementary Note 3]

The language processing device according to Supplementary Note 2, in which the processor sets, as the second morpheme, a morpheme selected randomly from a first morpheme string obtained by performing morphological analysis on the text data indicating the original sentence.

### [Supplementary Note 4]

The language processing device according to Supplementary Note 2 or 3, in which the processor converts a third morpheme having a standard notation into the predetermined standard notation among third morphemes obtained by connecting a plurality of adjacent second morphemes and performing the morphological analysis.

### [Supplementary Note 5]

The language processing device according to Supplementary Note 2, in which the converting the first morpheme on the basis of the pronunciation is converting the first morpheme into a hiragana in a case where the original sentence is in Japanese.

### [Supplementary Note 6]

The language processing device according to Supplementary Note 1, in which
the processor is further configured to:
create a correct token string on the basis of comparison information for dividing the error sentence and the original sentence in a predetermined processing unit to obtain an error sentence token string and an original sentence token string and correcting the error sentence token string to the original sentence token string;
generate a prediction token string forming the prediction sentence from the token string of the error sentence on the basis of the language model parameter; and update the language model parameter on the basis of the correct token string and the prediction token string.

### [Supplementary Note 7]

A language processing method executed by a language processing device having a language model based on a neural network model, the language processing method including,
by the language processing device:
generating an error sentence corresponding to an original sentence on the basis of pronunciation corresponding to text data indicating the original sentence;
generating a prediction sentence from the error sentence on the basis of a language model parameter of the language model; and
updating the language model parameter on the basis of a difference between the original sentence and the prediction sentence.

### [Supplementary Note 8]

A non-transitory recording medium storing a program for causing a computer to execute the method according to Supplementary Note 7.

### REFERENCE SIGNS LIST

1 Communication system
3 Language processing device
5 Communication terminal
30 Input unit
31 Error generation unit
32 Label creation unit
33 Language model unit
34 Update unit
39 Output unit

1. A language processing device configured to perform language processing, the language processing device comprising:
circuitry configured to
generate an error sentence corresponding to an original sentence based on pronunciation corresponding to text data indicating the original sentence;
use a language model based on a neural network model and generate a prediction sentence from the error sentence based on a language model parameter of the language model; and
update the language model parameter based on a difference between the original sentence and the prediction sentence.

2. The language processing device according to claim 1, wherein the circuitry is configured to
generate the error sentence by converting, into a second morpheme, a first morpheme included in, the text data indicating the original sentence based on pronunciation of the first morpheme;
convert the second morpheme into a predetermined standard notation; and
generate the error sentence based on the predetermined standard notation.

3. The language processing device according to claim 2, wherein the circuitry is configured to set, as the second morpheme, a morpheme that is selected randomly from a first morpheme string, the first morpheme string being obtained by performing morphological analysis on the text data indicating the original sentence.

4. The language processing device according to claim 2, wherein the circuitry is configured to convert a third morpheme having a standard notation into the predetermined standard notation, the third morpheme being selected from among third morphemes that are obtained by connecting adjacent second morphemes and performing morphological analysis.

5. The language processing device according to claim 2, wherein the second morpheme is hiragana in a case where the original sentence is in Japanese.

6. The language processing device according to claim 1, wherein the circuitry is configured to
create a correct token string based on comparison information for correcting an error sentence token string to an original sentence token string, the error sentence token string and the original sentence token string being each obtained by dividing a corresponding sentence among the error sentence and the original sentence, in a process unit;
generate, based on the language model parameter, a prediction token string included in the prediction sentence, from a token string of the error sentence; and
update the language model parameter based on the correct token string and the prediction token string.

7. A language processing method executed by a language processing device, the language processing method comprising
generating an error sentence corresponding to an original sentence based on pronunciation corresponding to text data indicating the original sentence;
generating a prediction sentence from the error sentence based on a language model parameter of a language model that is based on a neural network model; and
updating the language model parameter based on a difference between the original sentence and the prediction sentence.

8. A non-transitory computer medium storage medium storing a program for causing a computer to execute the language processing method of claim 7.
